(19) United States
(12) Patent Application Publication
(10) Pub. No.: US 2012/0288136 A1
(43) Pub. Date: Nov. 15, 2012

(54) PAPER-SHEET RECOGNITION DEVICE AND PAPER-SHEET PROCESSING APPARATUS

(76) Inventors: Tomohiko KASUYA, Hyogo (JP); Norikazu Taketani, Hyogo (JP); Kazuhiro Ohmatsu, Hyogo (JP); Naoaki Kagotani, Hyogo (JP); Hiroyuki Yanai, Hyogo (JP)

(21) Appl. No.: 13/467,359

(22) Filed: May 9, 2012

(30) Foreign Application Priority Data
May 12, 2011 (JP) 2011-107124

(51) Int. Cl. G06K 9/00

(52) U.S. Cl. 382/100

(57) ABSTRACT

A paper-sheet recognition device includes a sensor that detects the paper sheet being transported one by one to be recognized; an image capturing unit that captures an image of the paper sheet detected by the sensor; a recognition processing unit that recognizes the type of the paper sheet based on the paper sheet image captured by the image capturing unit; and a power consumption controller that controls power consumption by operating the image capturing unit and the recognition processing unit in a normal mode until the recognition of the paper sheet is completed after the paper sheet is detected by the sensor, and by stopping the operations of the image capturing unit and the recognition processing unit in a power-saving mode after completion of the recognition process.

### BACKGROUND OF THE INVENTION

1. Field of the Invention

The present invention relates to a paper-sheet recognition device that recognizes paper sheets, such as, banknotes and checks, and a paper-sheet processing apparatus including the paper-sheet recognition device. More particularly, the present invention relates to a paper-sheet recognition device that is operable in a power-saving mode in which power consumption is low and a paper-sheet processing apparatus including the paper-sheet recognition device.

2. Description of the Related Art

Among banknote processing apparatuses that recognize a denomination and an authenticity of a banknote and perform depositing and dispensing process of the banknote, some of the banknote processing apparatuses operate in a power-saving mode. For example, an automatic teller machine (ATM) disclosed in Patent Document 1 includes a communication unit that is switched from a normal mode to a power-saving mode when the communication unit does not communicate for a predetermined time.

In the automatic teller machine, processing is performed while performing transmission and reception of information pertaining to an account and a depositing and dispensing amount between the automatic teller machine and an external terminal. As disclosed in Japanese Patent Application Laid-open No. 2010-176601, the automatic teller machine operates in the normal mode when the communication unit is transmitting and receiving data, and switches from the normal mode to the power-saving mode once transmission and reception of data is completed. The power-saving mode is realized by controlling electric power supplied to each component. Specifically, electric power supplied to a shutter of a depositing/dispensing safe that stores therein the banknotes, a motor that drives a transport unit for transporting the banknotes, an escrow unit that temporarily escrows the banknotes that are being processed, etc., is controlled.

However, the automatic teller machine disclosed in Japanese Patent Application Laid-open No. 2010-176601 does not switch to the power-saving mode until a process pertaining to depositing or dispensing of the banknote is completed. During the depositing process or the dispensing process, even after recognition process of banknotes by a recognition unit is completed, the electric power is supplied to the idle recognition unit.

Specifically, for example, when performing a process for depositing banknotes to the automatic teller machine, the recognition unit recognizes the denomination, the authenticity, etc., of the deposited banknotes. Based on recognition results, the escrow unit temporarily escrows genuine banknotes and returns non-genuine banknotes to a user. Thereafter, processes, such as, transmission of deposited amount data to an external upper terminal, update of an account based on the transmitted data, etc., are performed in a state in which the banknote is escrowed by the escrow unit. After completion of the depositing process, the genuine banknotes escrowed by the escrow unit are transported to and stored in a storing unit. Thus, even after completion of a recognition process of the deposited banknotes, supply of the electric power to the recognition unit is continued although it is not operating during a series of subsequent processes pertaining to the deposited banknotes.

### SUMMARY OF THE INVENTION

The present invention is made in view of the above discussion and it is an object of the present invention to provide a paper-sheet recognition device in which power consumption can be reduced as well as accurately performing the recognition process of the paper sheet, such as, the banknote, and a paper-sheet processing apparatus including the paper-sheet recognition device.

According to an aspect of the present invention, a paper-sheet recognition device, which recognizes a type of a paper sheet being transported, includes a sensor that detects the paper sheet to be recognized; an image capturing unit that captures an image of the paper sheet detected by the sensor; a recognition processing unit that recognizes the type of the paper sheet based on the paper sheet image captured by the image capturing unit; and a power consumption controller that controls power consumption by operating the image capturing unit and the recognition processing unit in a normal mode until the recognition of the paper sheet is completed after the paper sheet is detected by the sensor, and by stopping the operations of the image capturing unit and the recognition processing unit in a power-saving mode after completion of the recognition process.

According to another aspect of the present invention, a paper-sheet processing apparatus includes a paper-sheet recognition device. The paper-sheet recognition device includes a sensor that detects a paper sheet to be recognized, an image capturing unit that captures an image of the paper sheet detected by the sensor, a recognition processing unit that recognizes a type of the paper sheet based on the paper sheet image captured by the image capturing unit, and a power consumption controller that controls power consumption by operating the image capturing unit and the recognition processing unit in a normal mode until the recognition of the paper sheet is completed after the paper sheet is detected by the sensor, and by stopping the operations of the image capturing unit and the recognition processing unit in a power-saving mode after completion of the recognition process.

The above and other objects, features, advantages and the technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram showing a structure of a banknote processing apparatus according to a first embodiment of the present invention;

FIGS. 2A and 2B are schematic diagrams showing an outer appearance and an internal structure, respectively, of a banknote recognition device according to the first embodiment;

FIG. 3 is a block diagram of the banknote recognition device according to the first embodiment;

FIGS. 4A and 4B are timing charts showing a mode switching control timing of the banknote recognition device according to the first embodiment;

FIG. 5 is a flow chart of a mode switching method according to the first embodiment;

FIG. 6 is a block diagram of a banknote processing apparatus according to a second embodiment of the present invention; and

FIG. 7 is a drawing showing an example of a power-saving-mode setting screen of the banknote processing apparatus according to the second embodiment.

### DETAILED DESCRIPTION OF THE PREFERRED EMBODIMENTS

Exemplary embodiments of a paper-sheet recognition device and a paper-sheet processing apparatus including the paper-sheet recognition device according to the present invention are explained in detail below with reference to the accompanying drawings. The paper-sheet recognition device can process various paper sheets, such as, banknotes, checks, and gift coupons; however, in the following embodiments a banknote is presented as an example of a paper sheet, and a banknote recognition device that can recognize a denomination, etc., of the banknote and a banknote processing apparatus including the banknote recognition device are explained.

The banknote recognition device according to a first embodiment is unitized, and used by integrating it into the banknote processing apparatus. An overview of the banknote processing apparatus with the banknote recognition device integrated therewith is explained below. Hereinafter, the unitized banknote recognition device is simply referred to as “recognition unit”.

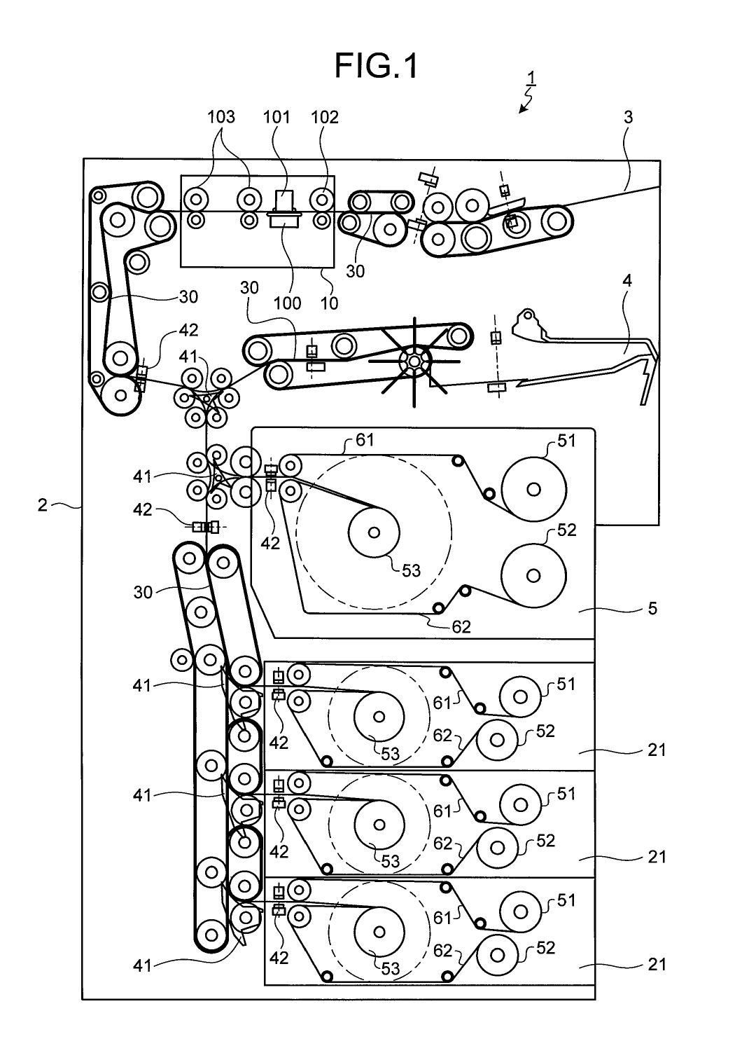

FIG. 1 is a schematic diagram showing an internal structure of a banknote processing apparatus 1. The banknote processing apparatus 1 is capable of performing a depositing process and a dispensing process.

In the depositing process, the banknotes to be deposited are received in an inlet 3. The received banknotes are fed one by one into a housing 2 and transported along a transport path 30. The banknotes are recognized by a recognition unit 10 that is arranged on the transport path 30. Thereafter, based on a recognition result, the banknote are stored in any of a plurality of storing units 21 arranged so as to, for example, store the banknotes denomination-wise. A plurality of sensors 42 arranged on the transport path 30 detects a position of the banknote that is being transported. Diverters 41 are arranged at positions where the transport path 30 diverges, and, based on position information of the banknote detected by the sensors 42 and the recognition result obtained by the recognition unit 10, destinations of the banknotes are switched.

In the dispensing process, the banknotes stored in the storing units 21 are fed out therefrom. The banknotes can be transported in a forward direction or a reverse direction on the transport path 30. The banknotes fed out from the storing units 21 are dispensed to an outlet 4.

The storing unit 5 is a cassette-type storing unit that is detachable from the housing 2. When the storing unit 5 is detached, the banknotes in the storing unit 5 can be taken out or banknotes can be refilled into the storing unit 5. When collecting the banknotes from the banknote processing apparatus 1, the banknotes fed from the storing units 21 are transported along the transport path 30 and stored in the storing unit 5. The storing unit 5 is removed from the housing 2 and the stored banknotes are collected. When refilling the banknote processing apparatus 1 with the banknotes, the storing unit 5 is detached from the housing 2, banknotes are refilled in the storing unit 5, the storing unit 5 is attached to the housing 2, and the banknotes in the storing unit 5 are supplied to the storing units 21.

The cassette-type storing unit 5 and the storing unit 21 are tape-type storing units. That is, these storing units internally include two tape reels 51 and 52 that are, respectively, wound with tapes 61 and 62, and a roller 53 that is wound with a tape unwound from the tape reels 51 and 52. Rotation of the roller 53 in a clock-wise direction causes the banknote transported along the transport path 30 to be wound on the roller 53 such that it is sandwiched between the tapes 61 and 62. When feeding the stored banknotes, the wound banknote is fed to the transport path 30 by the rotation of the roller 53 in a counter-clockwise direction.

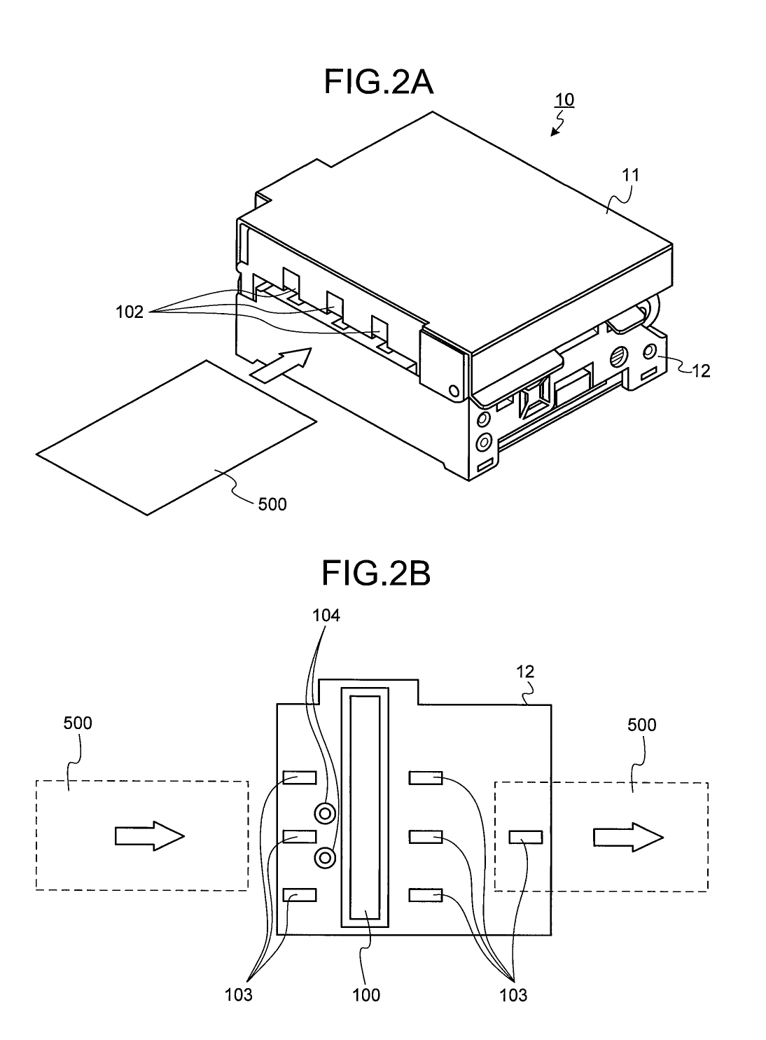

An overview of the recognition unit 10 according to the present embodiment is explained below. As shown in FIG. 1, the recognition unit 10 is arranged such that it partially forms the transport path 30 inside the banknote processing apparatus 1. FIG. 2A shows an outer appearance of the recognition unit 10 and FIG. 2B shows a movement of the banknote to be recognized through the recognition unit 10.

As shown in FIG. 2A, the recognition unit 10 receives a banknote 500 between an upper unit 11 and a lower unit 12 that constitute the recognition unit 10. As shown in FIG. 2B, the lower unit 12 includes a contact image sensor 100, rollers 102 arranged on an upstream side (the inlet 3 side) and rollers 103 arranged on a downstream side of the contact image sensor 100. Hereinafter, the contact image sensor is simply referred to as “CIS”.

As shown in FIG. 1, the upper unit 11 includes the rollers 102 and 103 similar to those of the lower unit 12 at positions facing the rollers 102 and 103 of the lower unit 12 in a vertical direction. By the rotation of the rollers 102 and 103, the banknote 500 received by the recognition unit 10 is transported via the CIS 100 and delivered outside the recognition unit 10. The delivered banknote 500 is subsequently transported along the transport path 30 inside the banknote processing apparatus 1.

The upper unit 11 includes a transmissive light source 101 at a position facing the CIS 100 in a vertical direction. The transmissive light source 101 irradiates with a light the banknote 500, which is transported by the rotation of the rollers 102 and 103, and the CIS 100 captures a transmission image of the banknote 500.

As shown in FIG. 2B, the recognition unit 10 includes a passage sensor 104 to detect the banknote 500 transported from the upstream side. The passage sensor 104 includes, for example, a light source and a light receiver. The banknote 500 that is being transported blocks the light irradiated from the light source, and as a result, the passage sensor 104 detects the banknote 500. After the recognition unit 10 detects the arrival of the banknote 500 by using the passage sensor 104, at a predetermined timing, the CIS 100 is operated to capture the transmission image of the banknote 500.

The recognition unit 10 uses the captured transmission image to recognize the denomination, authenticity, and fitness of the banknote 500. The recognition process of the banknote 500 is performed by comparing feature data extracted from a captured image of the banknote 500 with template data that is feature data previously prepared for the recognition. Specifically, for example, if the feature data extracted from the image matches with the template data of a 1000-yen banknote within a predetermined error range, and has differences that are greater than or equal to a predetermined value with the template data of other denominations, the banknote 500 is determined as a 1000-yen banknote.

A structure, functions, and operations of the banknote processing apparatus 1 pertaining to the banknote processes, such as, depositing, dispensing, collection, and refilling are similar to those of the conventional device; therefore, the detailed explanation thereof is omitted. Furthermore, a structure, functions, and operations of the recognition unit 10 pertaining to the recognition processes of the denomination, the authenticity, the fitness, etc., of the banknote 500 are also similar to those of the conventional device; therefore, the detailed explanation thereof is omitted.

In the recognition process performed by the recognition unit 10, a reflection image captured by the CIS 100 using a not shown light source for the reflection image is also used. However, for the sake of convenience, a case is explained below as an example in which only the transmission image is captured.

One of the features of the present embodiment is that the power consumption by the recognition unit 10 is reduced when the recognition processes of the denomination, the authenticity, the fitness, etc., of the banknote 500 is being performed. Meanwhile, the recognition processes of the denomination, the authenticity, the fitness, etc., of the banknote 500 are performed in the same or similar manner to those in the conventional technique. The structure and the operations performed to realize this feature are explained in detail below.

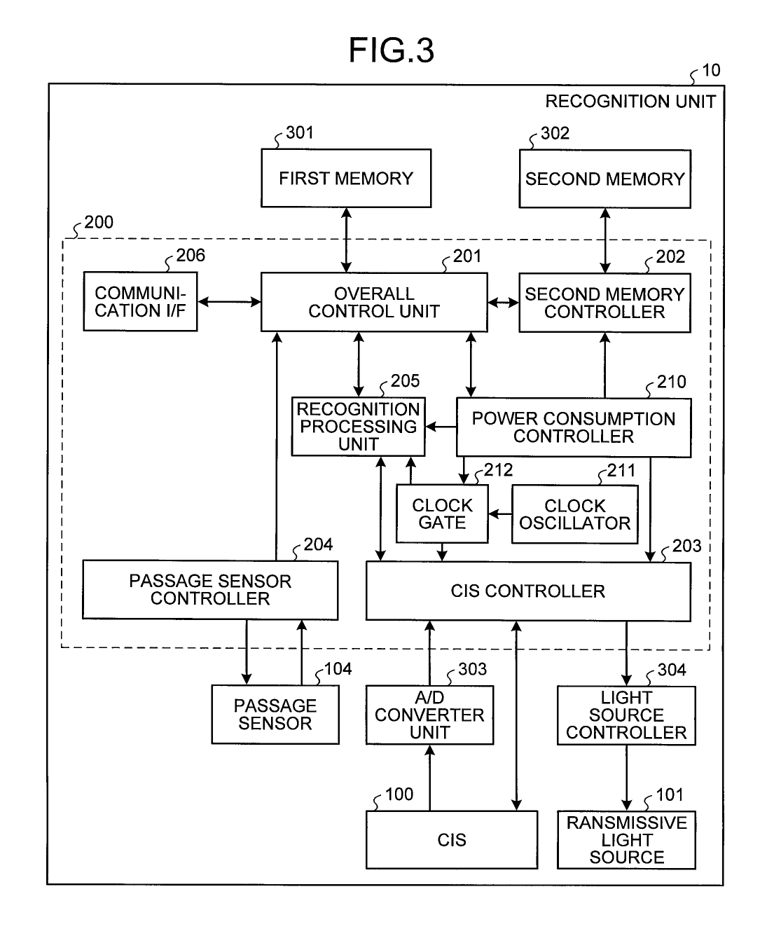

The structure of the recognition unit 10 according to the present embodiment is explained first. FIG. 3 is a block diagram of the recognition unit 10. The recognition unit 10 can be operated in two modes, that is, in a normal mode and in a power-saving mode. The normal mode is the same or similar as in the conventional technique. The power-saving mode is a mode in which the power consumption is suppressed. FIG. 3 shows structural elements necessary for explaining operation details in each mode and switching operations between these modes. Structural elements, such as, functional units similar to those of the conventional device are omitted.

As shown in FIG. 3, the recognition unit 10 includes the passage sensor 104, the transmissive light source 101, the CIS 100, an A/D converter unit 303 to perform A/D conversion of signals output from the CIS 100, a light source controller 304 to control the transmissive light source 101, a first memory 301, a second memory 302, and a control unit 200 to control each component mentioned above. The control unit 200 includes an overall control unit 201, a communication interface (hereinafter, referred to as “I/F”) 206 connected to the overall control unit 201, a second memory controller 202, a CIS controller 203, a passage sensor controller 204, a recognition processing unit 205, and a power consumption controller 210. Furthermore, the control unit 200 includes a clock oscillator 211 that generates a clock used in the operation of each component, and a clock gate 212 to control supply of the clock from the clock oscillator 211 to each component. Generally, PLL (Phase Locked Loop), etc., is frequently used as the clock oscillator 211. In FIG. 3, a clock supply line to each component from the clock oscillator 211 is omitted, and only the clock supply line necessary for explaining a later-described power-down mode is specified.

The communication I/F 206 has a function of performing data communication that includes reception of instruction signals from the recognition unit 10 and transmission of the recognition results to the outside, etc. The unitized recognition unit 10 is connected to a control unit of the banknote processing apparatus 1 via the communication I/F 206, and operates as a part of the banknote processing apparatus 1.

The control unit 200 is a functional unit that is realized by, for example, an FPGA (Field Programmable Gate Array). The overall control unit 201 in the control unit 200 reads and executes a software program stored in the first memory 301 that is constituted by an SDRAM, etc., and controls each component. Thus, the function and the operation of each component are realized. The second memory controller 202 saves the data required for exerting control over and performing the operation of each component into the second memory 302.

Each component constituting the control unit 200 operates by receiving the clock oscillated and supplied by the clock oscillator 211. If the supply of the clock stops, the operation of each component stops. The clock gate 212 arranged between the clock oscillator 211 and each component controls the supply of the clock. During the supply of the clock, dynamic consumption current flows to each component and after the supply of the clock stops, static consumption current flows to each component. Generally, the dynamic consumption current is significantly greater compared to the static consumption current. Therefore, the power consumption by each component can be suppressed by stopping the supply of the clock.

The passage sensor controller 204 has a function of detecting using the passage sensor 104 that the banknote 500 has arrived, and outputting a signal to the overall control unit 201 to notify the arrival of the banknote 500. The overall control unit 201 that has received the signal from the passage sensor controller 204 outputs a signal instructing the recognition processing unit 205 to start the recognition process.

Upon receiving the instruction from the overall control unit 201, the recognition processing unit 205 starts the recognition process of a type, such as, the denomination of the banknote 500 detected by the passage sensor 104, and outputs a signal instructing the CIS controller 203 to capture an image of the banknote 500.

Upon receiving the instruction from the recognition processing unit 205, the CIS controller 203 causes the light source controller 304 to irradiate a light of a predetermined wavelength from the transmissive light source 101 towards the banknote 500, and operates the CIS 100 to start measurement of the transmitted light to the banknote 500.

The A/D converter unit 303 converts an analog signal corresponding to each pixel data read and serially outputted by the CIS 100 to a digital signal. The digital signal is outputted from the A/D converter unit 303 and is inputted into the CIS controller 203. The CIS controller 203 outputs the digital signal received from the A/D converter unit 303 to the recognition processing unit 205.

The recognition processing unit 205 generates the transmission image data of the banknote 500 from the digital signal that is measured by the CIS 100 and inputted via the A/D converter unit 303 and the CIS controller 203, and acquires via the overall control unit 201 the template data for recognition saved in the first memory 301. Thereafter, the recognition processing unit 205 performs the recognition process to determine the denomination, etc., of the banknote 500 by comparing the feature data extracted from the image and the template data for recognition as described above.

Thus, a series of processes in which the image of the banknote 500 is captured, the denomination, etc., of the banknote 500 is recognized based on the captured image of the banknote 500, and the recognition result is obtained, is performed in the normal mode. That is, an operation mode used while performing the recognition process is the normal mode. In the normal mode, each component operates by consuming the electric power similar to that of the conventional device. In contrast, the power-saving mode is realized in which the power consumption is suppressed by the power consumption controller 210.

The power consumption controller 210 has a function of switching the operation modes of the recognition unit 10 between the normal mode and the power-saving mode. The power-saving mode is realized by stopping the operation of certain predetermined functional units at a predetermined timing and operating certain other predetermined functional units in the power-down mode.

Switching timing details of the normal mode and the power-saving mode are explained after explanation of the details of the power-saving mode realized by the recognition unit 10.

In the power-saving mode, the power consumption controller 210 stops the supply of the clock to the CIS controller 203, the recognition processing unit 205, the light source controller 304, the transmissive light source 101, and the CIS 100. Specifically, the supply of the clock is stopped by controlling the clock gate 212 arranged between the clock oscillator 211 and each component. Consequently, each component remains in an off state in which the operation of each component is stopped.

In the power-saving mode, the power consumption controller 210 switches the operations of the A/D converter unit 303, the second memory controller 202, and the second memory 302 to the power-down mode operations. Thus, these components remain in a power-down state in which only internal data is maintained.

Because the data necessary for the operation of each component constituting the control unit 200 is stored in the second memory 302, it is necessary to maintain the internal memory contents not only in the normal mode but also in the power-saving mode. Therefore, even in the power-saving mode, the second memory controller 202 sets the second memory 302 so that it can continue to operate.

Specifically, when switching the operation mode of the recognition unit 10 to the power-saving mode, the power consumption controller 210 issues an instruction command to the second memory controller 202 to change the operation mode. Upon receiving the instruction command, the second memory controller 202 writes to the second memory 302 a command instructing a self-refresh operation that is the operation to be performed in the power-saving mode. As a result, the second memory 302 performs the self-refresh operation even in the power-saving mode and maintains the memory contents. When the second memory 302 returns to the operation in the normal mode, the second memory controller 202 writes a command instructing a normal operation to the second memory 302.

The A/D converter unit 303 stores therein setting values, such as, offset and gain, that are required for converting the signal received from the CIS 100. Therefore, likewise, only the operation for maintaining the setting values in the A/D converter unit 303 during the power-saving mode is continued.

Thus, only the functional units, which are associated with the recognition process including from capturing the image of the banknote 500 up to obtaining the recognition result, are target to switch the operation to the power-saving mode. The operations of functional units, which need to be operated other than when performing the recognition process, are continued as in the normal mode even in the power-saving mode.

Specifically, the operations similar to those in the normal mode are continued even in the power-saving mode for the power consumption controller 210 that switches the operation mode, the passage sensor 104 and the passage sensor controller 204 that detect the banknote 500, the communication I/F 206 that receives the signals from outside, the overall control unit 201 that controls the operations of all the components mentioned above, the first memory 301 used for saving therein the data used in each component, the clock oscillator 211 and the clock gate 212 that supply the operation clock to each component.

An example in which the recognition unit 10 is constituted by the FPGA 200 and the operations of the predetermined functional unit are stopped by controlling the supply of the clock is explained in the present embodiment; however, the present embodiment is not limited to this example. For example, the operations of the power consumption controller 210 can be stopped by stopping the power supply from a not shown power source, and a status thereof can be changed to the power-down state by reducing the power supply. An aspect of the invention is that the operation of each component is stopped according to the contents of the processes executed in the recognition unit 10 and the operations are performed with low power consumption than in the normal mode, and the invention is not limited to the example of this embodiment.

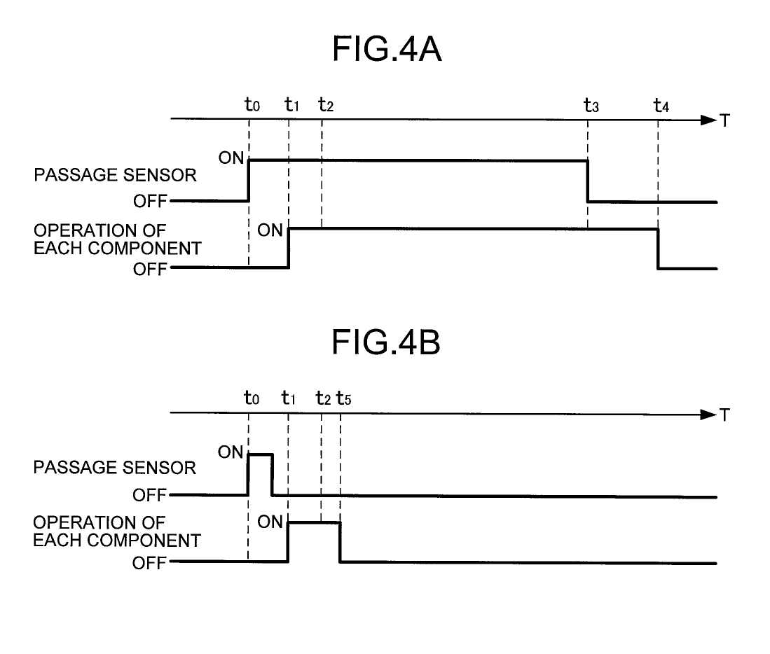

A switching process between the normal mode and the power-saving mode is explained below. FIGS. 4A and 4B are timing charts explaining switching of the operation modes. In FIGS. 4A and 4B, the horizontal axis represents time (T). A status of the passage sensor 104 in which the banknote is not detected is denoted as OFF state and a status in which the banknote is detected is denoted as ON state. Furthermore, the operation status of each component whose operation is stopped or in the power-down state in the power-saving mode, is denoted as ON in the normal mode and OFF in the power-saving mode.

As shown in FIG. 4A, if the passage sensor 104 detects the banknote 500 when each component is in the power-saving mode, that is, in the OFF state (T=t₀), the power consumption controller 210 switches the operation mode of each component from the power-saving mode to the normal mode for performing recognition of the banknote 500.

Thus, in the functional unit, such as, the recognition processing unit 205, to which the supply of the clock is stopped and the operation thereof is stopped in the power-saving mode, the operation in the normal mode starts immediately after the operation mode is switched (T=t₀). However, the operation of the functional unit, such as, the A/D converter unit 303, which is in the power-down state, starts in the normal mode slightly after the operation mode is switched (T=t₁). That is, the initial operation is performed after the operation mode is switched, and the operations of the recognition unit 10 in the normal mode start after a predetermined time is elapsed from when the initial operation is completed. However, a time period from the time t₀ to the time t₁ is short. For example, the operations in the normal mode start within 5 milliseconds (msec) after the operation mode is switched.

Once the operations in the normal mode are started, the banknote 500 detected by the passage sensor 104 is subjected to the image capturing process and the recognition process. As shown in FIG. 4A, the operation of each component in the normal mode continues during the recognition process of the banknote 500 even after the banknote 500 passes through a position of the passage sensor 104 and the passage sensor 104 is in the OFF state. At a timing (T=t₄), when, upon acquiring the recognition results of the banknote 500, the power consumption controller 210 recognizes that the recognition process is completed, the operation mode is switched from the normal mode to the power-saving mode. That is, in order to change the ON state of predetermined functional units to the OFF state, the supply of the clock to the recognition processing unit 205, etc., is stopped, the transmissive light source 101 is turned off, reading of the signals outputted from the CIS 100 is discontinued, and the operation of the A/D converter unit 303, etc., is changed to the power-down state.

Thus, once the banknote 500 is detected by the passage sensor 104, the operation mode is switched from the power-saving mode to the normal mode, and once the recognition process is completed and the recognition result of the banknote 500 is acquired after the banknote 500 passes through the passage sensor 104, the operation mode is switched from the normal mode to the power-saving mode. Because the operation mode can be switched to the power-saving mode each and every time of the completion of the recognition process even when the banknotes are successively transported, the power consumption by the recognition unit 10 can be finely controlled. Consequently, the power consumption by the recognition unit 10 can be reduced.

In the recognition unit 10, the measures are taken also when a banknote is erroneously detected due to noise, etc. Specifically, as shown in FIG. 4B, because the banknote does not exist in actual when the passage sensor 104 is turned on due to the erroneous detection of the banknote (T=t₀), signals output from the passage sensor 104 are immediately turned off. As explained before, upon receiving the signal that the passage sensor 104 is ON, the power consumption controller 210 switches the operation mode from the power-saving mode to the normal mode. At a predetermined timing (T=t₂), that is, 5 msec after the passage sensor 104 is turned on, the power consumption controller 210 once again checks a status of the signals output from the passage sensor 104. Upon recognizing that the signal output from the passage sensor 104 is turned off, the power consumption controller 210 switches the operation mode from the normal mode to the power-saving mode.

Thus, the status of the passage sensor 104 is checked once again at the predetermined timing after the passage sensor 104 is turned on. Because the operation mode returns again to the power-saving mode in case of erroneous detection, wasteful power consumption can be avoided.

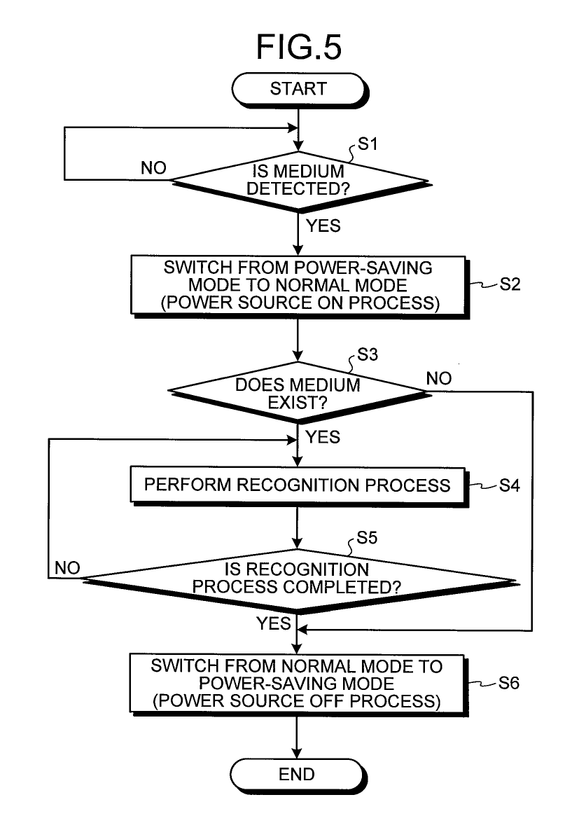

FIG. 5 is a flowchart explaining a process procedure for switching between the modes described in FIG. 4. As shown in FIG. 5, when a banknote that is a medium to be recognized is detected by the recognition unit 10 (Step S1), the power consumption controller 210 starts a process of switching the operation mode from the power-saving mode to the normal mode (Step S2). This switching process is performed by the power consumption controller 210 to start the supply of the clock and the power supply to the predetermined functional unit so that the power source of each component is turned on and the operation can be started in the normal mode.

Thereafter, the status of the passage sensor 104 is checked once again and if the banknote that is to be processed exists (Yes at Step S3), the recognition process is started (Step S4). However, if the status of the passage sensor 104 is OFF and the banknote to be processed does not exist (No at Step S3), the power consumption controller 210 immediately starts a process to return the operation mode to the power-saving mode (Step S6).

If the banknote to be processed exists (Yes at Step S3) and the recognition process starts (Step S4), the process continues until the recognition result is acquired (No at Step S5). After completion of the recognition process (Yes at Step S5), the power consumption controller 210 starts the process of switching the operation mode from the normal mode to the power-saving mode. This switching process is performed by the power consumption controller 210 to stop the supply of the clock and the power supply to the predetermined functional unit and to switch the operation mode of the predetermined functional unit to the power-down mode so that the operation in the power-saving mode can be started.

As described above, in the present embodiment, the operation mode is switched between the normal mode and the power-saving mode in the recognition unit 10. The recognition unit 10 determines the start and the end of the recognition process of the banknote 500 to switch the operation mode. In the power-saving mode, the power consumption is suppressed as compared to the normal mode. Thus, when the recognition process is being performed, the operations in the normal mode are performed, and when the recognition process is not performed, the operation mode is switched to the power-saving mode and the power consumption is reduced. Because the operation mode can be changed in each process for each banknote, the power consumption can be finely controlled and more effectively reduced. Furthermore, because the recognition unit 10 independently performs switching of the operation mode, the power consumption can be reduced irrespective of the functions of the banknote processing apparatus 1 the recognition unit 10 integrated therewith.

At the predetermined timing after the operation in the normal mode is started, it is checked once again that the recognition process of the banknote is being performed. If the recognition process is not being performed, the control is immediately exerted to return the operation mode to the power-saving mode, and therefore, wasteful power consumption is avoided.

Furthermore, in the power-saving mode, various operations can be controlled by classifying the functional units into the functional units constituting the recognition unit 10, the functional units operated similarly as in the normal mode, the functional units operated by suppressing the power consumption, and the functional units that stop the operations. Therefore, the power consumption can be reduced while realizing the operations similar to those of the conventional device.

In the power-saving mode, the supply of the clock to the recognition processing unit 205, etc., is stopped. Thus, unnecessary radio wave radiation is suppressed as compared to a case in which the clock is supplied to all the functional units, and noise that affects signal processing of each component can be reduced. Because the power consumption is suppressed, an amount of heat generation is reduced and a cooling device, such as, a cooling fan necessary for a stable operation is not required. As a result, reduction in the number of the structural components of the recognition unit 10, and reduction in a manufacturing cost and weight are attained.

As described in the first embodiment, the recognition unit 10 detects that the banknote 500 is being transported, and operates in the normal mode until the recognition process of the banknote 500 is completed. Furthermore, once the recognition process is completed, the recognition unit 10 is switched to the power-saving mode till the next banknote 500 is detected.

Similarly as the conventional recognition unit, the recognition unit 10 can always operates in the normal mode without switching the operation mode to the power-saving mode. A user can perform operations to set the banknote processing apparatus 1 so that the operation mode of the recognition unit 10 is switched to the power-saving mode.

In the present embodiment, how the settings pertaining to the power-saving mode are made is explained. In the present embodiment, the explanation of functions and operations that are similar to those of the first embodiment is omitted.

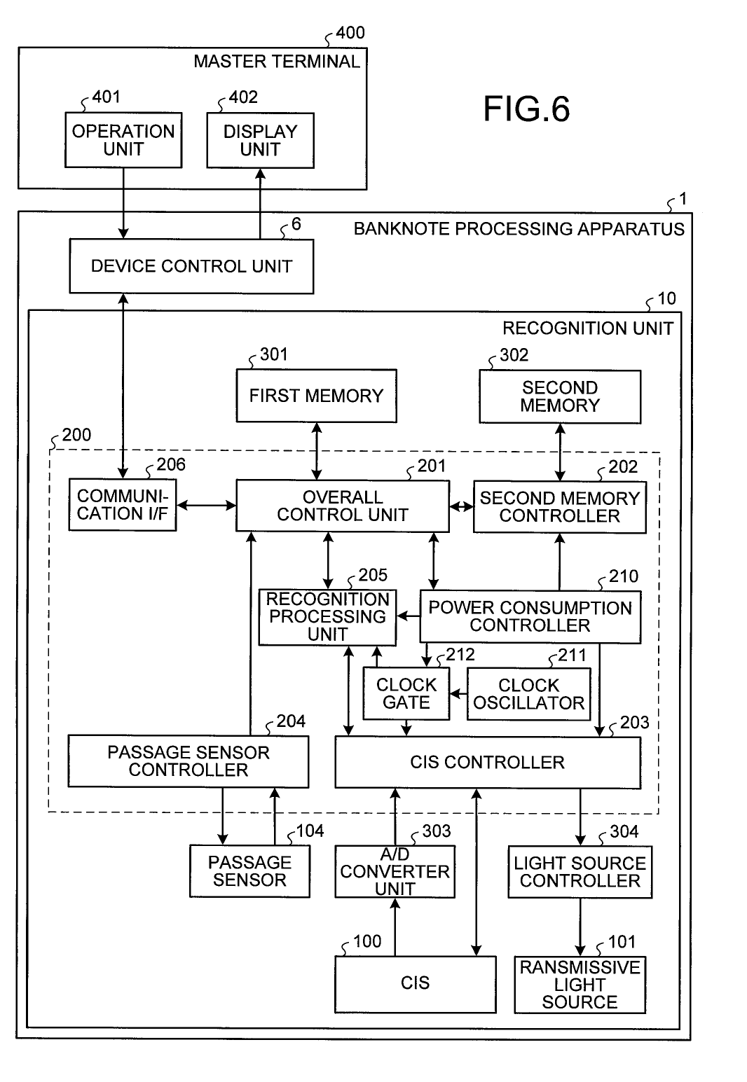

FIG. 6 is a block diagram showing an example of the utility of the recognition unit 10 explained in the first embodiment. As shown in FIG. 1, in the recognition unit 10, a transport path inside the recognition unit 10 that transports the banknote 500 via the CIS 100 is arranged so as to form a part of the transport path 30 inside the banknote processing apparatus 1.

As shown in FIG. 6, the overall control unit 201 in the recognition unit 10 is connected to a device control unit 6 that controls each component of the banknote processing apparatus 1 via the communication I/F 206. Furthermore, an upper terminal 400 constituted by a computer device, etc., is connected to the banknote processing apparatus 1. Thus, the functions and the operations of the banknote processing apparatus 1 can be performed from the upper terminal 400. Furthermore, setting details of the recognition unit 10 can be changed by performing the operation using an operation unit 401 while checking the information displayed on a display unit 402 on the master terminal 400.

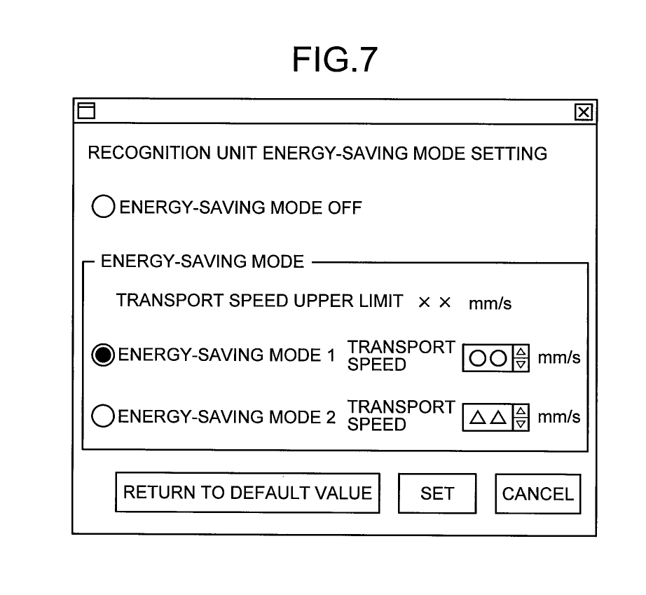

An example of the display contents displayed on the display unit 402 when performing settings of the recognition unit 10 is explained in FIG. 7. As shown in FIG. 7, on a setting screen pertaining to the power-saving mode of the recognition unit 10, a plurality of the operation modes that can be selected is displayed. For example, if “energy-saving mode off” is selected on the screen, the recognition unit 10 always operates in the normal mode without switching to the power-saving mode. If “energy-saving mode 1” or “energy-saving mode 2” is selected, the recognition unit 10 operates by switching the operation mode between the normal mode and the power-saving mode as described in the first embodiment. Furthermore, in the energy-saving modes 1 and 2, a transport speed of the banknote transported within the banknote processing apparatus 1 can be individually set.

If a time required till the recognition unit 10 becomes operable in the normal mode after the operation mode is switched from the power-saving mode to the normal mode is assumed to be, for example, 5 msec, the time period from the time the banknote 500 is detected by the passage sensor 104 and the operation mode is switched till the time the banknote 500 reaches the CIS 100 needs to be more than or equal to 5 msec. That is, after the banknote 500 subjected to the recognition process is detected, each component, such as CIS 100, needs to be operable in the normal mode before the recognition process starts. Therefore, a maximum transport speed of the banknote 500 is determined based on the time period, that is assumed to be 5 msec, required till the recognition unit 10 becomes operable in the normal mode after the operation mode is switched, and a distance from the passage sensor 104 to the CIS 100.

Specifically, if the distance from the passage sensor 104 to the CIS 100 is 5 millimeters (mm), the transport speed when the banknote 500 detected by the passage sensor 104 reaches the CIS 100 after 5 msec is 1000 mm/sec. Therefore, the maximum limit of the transport speed is 1000 mm/sec. If the banknote 500 is transported at a speed faster than or equal to 1000 mm/sec, the switching of the operation modes is delayed and a part of the banknote 500 passes through the CIS 100 before the operation in the normal mode starts. Consequently, the power-saving mode cannot be used.

On the setting screen of the operation mode of the recognition unit 10 shown in FIG. 7, an upper limit of the transport speed is calculated as described above and displayed. However, if a transport speed needs to be lower, for switching the transport path 30 by the diverter 41, than the transport speed determined based on the operation of the recognition unit 10, a lower transport speed is displayed as the upper limit. In the banknote processing apparatus 1, the operation unit 401 can set the transport speed less than or equal to the upper limit displayed on the display unit 402 as the transport speed of the energy-saving mode 1. If a value higher than the upper limit of the transport speed is set, the operation mode is automatically set to “energy-saving mode off”. Furthermore, on pressing a button for “default value” on the screen, the operation mode is automatically set to a mode that is a pre-set default mode and the transport speed is also set to a pre-set, value.

The banknote processing apparatus 1 requires to process a large number of banknotes at a high speed; however, by lowering the transport speed, the power consumption of each driving unit that drives the transport path 30, the diverter 41, etc., can be suppressed. A user of the banknote processing apparatus 1 can set the transport speed by taking into account a banknote processing speed required of the banknote processing apparatus 1, and power-saving effects. Because a plurality of energy-saving modes, that is, the energy-saving modes 1 and 2 is included, a different transport speed can be set in each mode and switching can be easily performed between the operation modes having different power-saving effects.

The information pertaining to the transport speed displayed on the display unit 402 can be displayed as the transport speed with a unit of “mm/sec” as shown in FIG. 7. Alternatively, the transport speed of the banknote 500 can be converted to be displayed as a banknote processing speed with a unit of “number of banknotes/min”. Furthermore, a user can select unit and display contents for the unit to be displayed, or set all units to be displayed on the screen.

When, by using the operation unit 401 of the upper terminal 400, the energy-saving mode 1 or the energy-saving mode 2 is selected and a set button is pressed, the device control unit 6 of the banknote processing apparatus 1 recognizes the selected mode and exerts control over a driving unit, etc., that drives a transport unit so as to transport the banknote 500 with the set transport speed. Similarly, the overall control unit 201 in the recognition unit 10 that receives the setting details from the device control unit 6 via the communication I/F 206 controls the rotation of the rollers 102 and 103 so as to transport the banknote 500 with the set transport speed, and the operation mode can be switched from the normal mode to the power-saving mode as described in the first embodiment.

If a setting is performed on the upper terminal 400 to turn the power-saving mode off, the banknote processing apparatus 1 operates without changing the transport speed before or after the setting. Furthermore, the operation mode of the recognition unit 10 is switched to the normal mode, and the recognition unit 10 always operates in the normal mode irrespective of whether the recognition process is being performed.

As described above, in the present embodiment, by operating the upper terminal 400, the operation mode of the recognition unit 10 can be changed. Thus, the recognition unit 10 can be always operated in the normal mode instead of in the power-saving mode.

When the recognition unit 10 is to be operated in the power-saving mode, the transport speed can be changed. By slowing the transport speed, the power consumption by the recognition unit 10 as well as by the banknote processing apparatus 1 can be suppressed. Furthermore, because the setting details are inputted into the device control unit 6 in the banknote processing apparatus 1 and the overall control unit 201 in the recognition unit 10, the transport speed in the banknote processing apparatus 1 and the recognition unit 10 can be synchronized.

In the power-saving mode, as described in the first embodiment, the supply of the clock to the recognition processing unit 205, etc., is stopped. Therefore, unnecessary radio wave radiation can be suppressed as compared to a case in which the clock is supplied to all the functional units. As a result, noise that affects the operations and the functions of the other functional units constituting the banknote processing apparatus 1 can be reduced.

As described above, the present invention is useful in reducing the power consumption by the paper-sheet recognition device that recognizes the paper-sheet, such as the banknote, and the paper-sheet processing apparatus including the paper-sheet recognition device.

According to the present invention, an image capturing unit and a recognition processing unit that perform a series of recognition processes operate only in a normal mode until an image of a paper sheet is captured and a recognition result is acquired after the paper sheet to be recognized is detected by a sensor. When the recognition process is not to be performed, an operation mode is switched to a power-saving mode and the operations of the image capturing unit and the recognition processing unit are stopped. Therefore, power consumption by a paper-sheet recognition device is reduced while accurately performing the recognition process of the paper sheet at a speed similar to that in the conventional device.

According to the present invention, operations of some of the functional units, such as, a memory and a memory controller can be continued in a low power-consumption state even in the power-saving mode without having to stop the operations of all the functional units. Therefore, saved data is maintained even while the power consumption is reduced.

According to the present invention, apart from stopping the operations by stopping the electric power supply, the operations of the functional units that operate based on a supplied clock can be stopped by stopping the supply of the clock or started by starting the supply of the clock. Therefore, switching between the power-saving mode and the normal mode is easily controlled using a programmable integrated circuit.

According to the present invention, the paper-sheet recognition device in which the power consumption can be reduced is integrated into the paper-sheet processing apparatus and used. Therefore, the power consumption by the paper-sheet processing apparatus is reduced while accurately performing the recognition process of the paper sheet at a speed similar to that in the conventional device.

According to the present invention, all the functional units constituting the paper-sheet recognition device can always operate in the normal mode according to a setting operation performed by an operation unit included in the paper-sheet processing apparatus. Therefore, for example, when the paper sheets have to be processed at a higher speed, the settings can be changed according to the purpose.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A paper-sheet recognition device that recognizes a type of a paper sheet being transported one by one along a transport passage, the device comprising:
a sensor that detects the paper sheet to be recognized;
an image capturing unit that captures an image of the paper sheet detected by the sensor;
a recognition processing unit that recognizes the type of the paper sheet based on the paper sheet image captured by the image capturing unit; and
a power consumption controller that controls power consumption by operating the image capturing unit and the recognition processing unit in a normal mode until the recognition of the paper sheet is completed after the paper sheet is detected by the sensor, and by stopping the operations of the image capturing unit and the recognition processing unit in a power-saving mode after the recognition of the paper sheet is completed.

2. The paper-sheet recognition device according to claim 1, further comprising:
a memory that stores therein data necessary for the operation of the recognition processing unit; and
a memory controller that controls storing and reading out of the data to and from the memory,
wherein the power consumption controller controls the memory and the memory controller in the power-saving mode, in which the power consumption is lower than in the normal mode, to maintain the data stored in the memory.

3. The paper-sheet recognition device according to claim 1, further comprising a clock oscillator that oscillates a clock used in the operations of the image capturing unit and the recognition processing unit,
wherein the power consumption controller switches an operation mode between the normal mode and the power-saving mode to control the supply of the clock from the clock oscillator.

4. A paper-sheet processing apparatus comprising:
a paper-sheet recognition device including
a sensor that detects a paper sheet to be recognized,
an image capturing unit that captures an image of the paper sheet detected by the sensor,
a recognition processing unit that recognizes a type of the paper sheet based on the paper sheet image captured by the image capturing unit, and
a power consumption controller that controls power consumption by operating the image capturing unit and the recognition processing unit in a normal mode until the recognition of the paper sheet is completed after the paper sheet is detected by the sensor, and by stopping the operations of the image capturing unit and the recognition processing unit in a power-saving mode after the recognition of the paper sheet is completed.

5. The paper-sheet processing apparatus according to claim 4, further comprising:
an operation unit that sets the operation of the paper-sheet recognition device,
wherein the power consumption controller causes the paper-sheet recognition device to always operate in the normal mode, when a setting that prohibits switching to the power-saving mode is set by using the operation unit.
